(19) United States
(12) Patent Application Publication
(10) Pub. No.: US 2017/0174358 A1
(43) Pub. Date: Jun. 22, 2017

(54) SYSTEMS AND METHODS FOR MULTILINGUAL AIRCRAFT TOWING COLLISION WARNING

(71) Applicant: Gulfstream Aerospace Corporation, Savannah, GA (US)

(72) Inventor: Thomas Landers, Savannah, GA (US)

(21) Appl. No.: 14/979,052

(22) Filed: Dec. 22, 2015

(51) Int. Cl. B64D 45/00

(52) U.S. Cl. CPC B64D 45/00

(57) ABSTRACT

Collision warning systems, collision warning devices, and methods of operating collision warning systems are disclosed herein. A collision warning system includes, but is not limited to, a plurality of proximity sensors and a computer device. The plurality of proximity sensors are configured to mount on an aircraft and to generate a proximity signal. The computer device is communicatively coupled with the plurality of proximity sensors and is configured to determine a location in which the collision warning system is located, where the location includes at least one of a country and a region. The computer device is further configured to select an active linguistic profile based on the location, where the active linguistic profile includes at least one of a language and a dialect. The computer device is yet further configured to alert ground crew of potential collisions using the active linguistic profile and based on the proximity signal.

### TECHNICAL FIELD

Embodiments of the present invention generally relate to aircraft with towing collision warning systems, and more particularly relate to methods and systems that warn tug drivers of potential collisions in a language determined by the location of the systems.

### BACKGROUND OF THE INVENTION

It is common to use a ground vehicle to move an aircraft when the aircraft is on the ground. For example, an operator of the ground vehicle must often drive and maneuver the aircraft using the ground vehicle during ground operations, such as when an aircraft is being maneuvered to or from a hangar, or being backed away from a terminal. The ground vehicle used to move the aircraft is commonly referred to as a tug, tractor or towing equipment.

In some cases, obstacles on the ground may lie in the path of a vehicle being towed. Examples of such obstacles include structures and other vehicles including other aircraft that are either stationary or moving. In some cases, these obstacles can be detected by the operator using natural vision. However, in many cases, due to the dimensions of the aircraft (e.g., large wing sweep angles, distance from cockpit to wingtip, etc.) and the ground vehicle operator's field of view of the areas surrounding the aircraft is limited, making it difficult for the ground vehicle operator to monitor extremities of the aircraft during towing operations (e.g., the ground vehicle operator may not be able to directly view extremities of the aircraft during towing operations). As a result, the operator of the ground vehicle may fail to detect obstacles that are located in certain “blind spots” that are in close proximity of the aircraft. In many cases, the ground vehicle operator may only detect an obstacle when it is too late to take the action needed to prevent a collision with the obstacle.

Collisions with an obstacle can not only damage the aircraft, but can also put the aircraft out of service and result in flight cancellations. The costs associated with the repair and grounding of an aircraft can be significant. Collisions with an obstacle can also lead to damage to fixed structures or other vehicles, such as parked aircraft, that are located within the tow path of the aircraft. As such, the timely detection and avoidance of obstacles is an important issue that needs to be addressed.

Furthermore, aircraft often travel to locations where the ground vehicle operators speak languages that are different from the native language of the flight crew. Accordingly, a collision warning system that travels with the aircraft but does not have robust multilingual support may be difficult for some ground vehicle operators to use. As such, there is room for improvement in warning of potential towing collisions. Accordingly, it is desirable to provide a collision warning system that is operable for ground crews in various countries who speak various languages and dialects. Furthermore, other desirable features and characteristics will become apparent from the subsequent detailed description and the appended claims, taken in conjunction with the accompanying drawings and the foregoing technical field and background.

### SUMMARY

Collision warning systems, collision warning devices, and methods of operating collision warning systems are disclosed herein.

In a first non-limiting embodiment, a collision warning system includes, but is not limited to, a plurality of proximity sensors and a computer device. The plurality of proximity sensors are configured to mount on an aircraft, or be designed as part of the aircraft and to generate a proximity signal. The computer device is communicatively coupled with the plurality of proximity sensors and is configured to determine a location in which the collision warning system is located, where the location includes at least one of a country and a region. The computer device is further configured to select an active linguistic profile based at least on part on the location, where the active linguistic profile includes at least one of a language and a dialect. The computer device is yet further configured to alert ground crew of potential collisions using the active linguistic profile and based on the proximity signal.

In a second non-limiting embodiment, a collision warning device includes, but is not limited to, a display, a location sensor, and a communications interface. The location sensor is configured to generate a location signal and the communications interface is configured to receive a proximity signal from a plurality of proximity sensors mounted on the aircraft. The collision warning device is configured to determine a location in which the collision warning device is located based on the location signal, where the location includes at least one of a country and a region. The collision warning device is further configured to select an active linguistic profile based at least on part on the location, wherein the active linguistic profile includes at least one of a language and a dialect. The collision warning device is yet further configured to alert ground crew of potential collisions of the aircraft with an object using the active linguistic profile and based on the proximity signal.

In a third non-limiting embodiment, a method for selecting an active linguistic profile for a collision warning system includes, but is not limited to, determining, with a computer device, a location in which the collision warning system is located, where the location includes at least one of a country and a region. The method further includes selecting the active linguistic profile based at least on part on the location, where the active linguistic profile includes at least one of a language and a dialect. The method yet further includes alerting ground crew of potential collisions using the active linguistic profile and based on a proximity signal generated by a proximity sensor mounted on an aircraft.

### DESCRIPTION OF THE DRAWINGS

Embodiments of the present invention will hereinafter be described in conjunction with the following drawing figures, wherein like numerals denote like elements, and

FIG. 1 is a side view illustrating an aircraft that includes a non-limiting embodiment of an aircraft towing collision warning system in accordance with the teachings of the present disclosure;

FIG. 2 is a simplified block diagram illustrating the aircraft towing collision warning system of FIG. 1 in accordance with the teachings of the present disclosure; and

FIG. 3 is a flow diagram illustrating an algorithm performed by the aircraft towing collision warning system of FIG. 2 in accordance with the teachings of the present disclosure.

### DESCRIPTION OF EXEMPLARY EMBODIMENTS

The following detailed description is merely exemplary in nature and is not intended to limit the invention or the application and uses of the invention. Furthermore, there is no intention to be bound by any theory presented in the preceding background or the following detailed description.

As will be described in greater detail below, the disclosed embodiments provide systems for selecting a language and dialect with which to operate an aircraft towing collision warning system. Operating the system may include navigating menus of the system and/or may include signaling, in the selected language and dialect, an operator of a ground vehicle that potential obstacles are present near an aircraft. The collision warning system may utilize proximity sensors that are integrated with an aircraft or that are detachable for use on multiple aircraft.

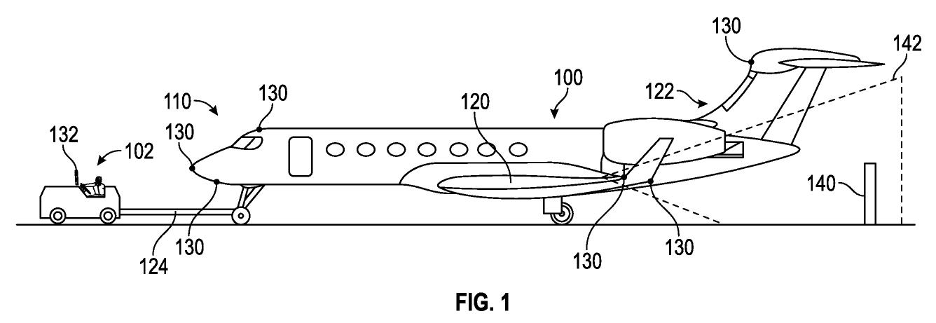

FIG. 1 is a side view of an aircraft 100 being towed by a ground vehicle 102 that is using a multilingual aircraft towing collision warning system 110 in accordance with the teachings of the present disclosure. As will be described below, collision warning system 110 may be used to reduce or eliminate the likelihood of collision of aircraft 100 with ground obstacles near aircraft 100 when aircraft 100 is being moved on a ground surface by ground vehicle 102. In some embodiments, towing collision warning system 110 may be utilized in other towing situations, such as towing boats, trailers, fork lift payloads, and the like.

Aircraft 100 includes main wings 120 and empennage 122. As will be appreciated by those with ordinary skill in the art, empennage 122 may have vertical stabilizers, horizontal stabilizers, “V” stabilizers, or other extremities that may be damaged during towing. In the example provided, ground vehicle 102 is a tug coupled with aircraft 100 by a mechanical link 124.

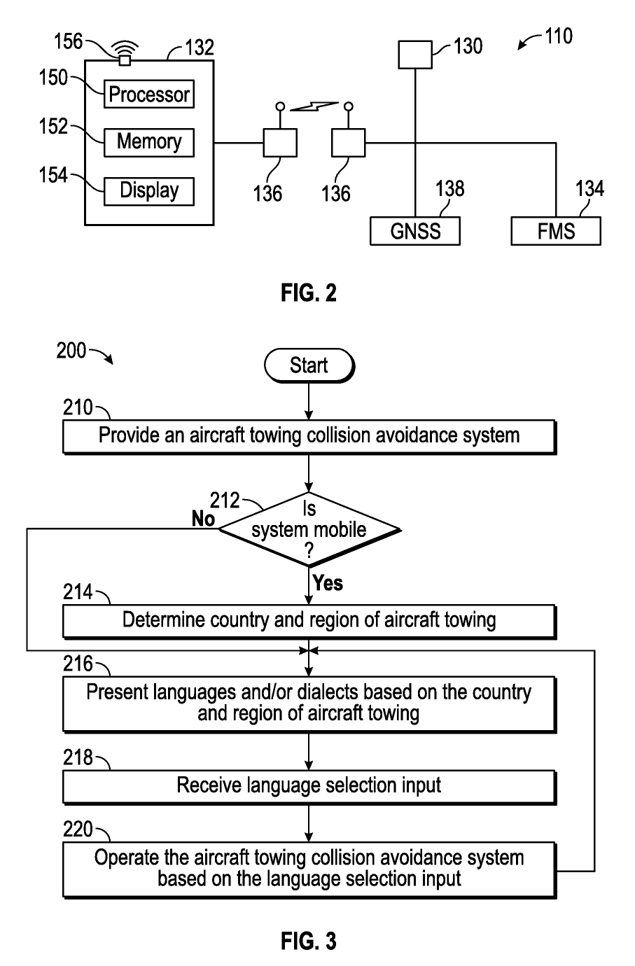

Referring now to FIG. 2, and with continuing reference to FIG. 1, further details of a collision warning system are illustrated in accordance with teachings of the present disclosure. In the example provided, collision warning system 110 includes a plurality of proximity sensors 130, a computer device 132, a Flight Management System 134, a pair of communications interfaces 136, and a location sensor 138. In some embodiments, collision warning system 110 may include any suitable additional sensors and ground crew alerting components. For example, collision warning system 110 may include components described in any of the systems of copending U.S. patent application Ser. No. 14/159,064, filed Jan. 20, 2014, copending U.S. patent application Ser. No. 14/599,758, filed Jan. 19, 2015, or copending U.S. patent application Ser. No. 14/674,916, which are all hereby incorporated by reference.

In the exemplary embodiment illustrated in FIG. 1, proximity sensors 130 are mounted on a horizontal stabilizer, a vertical stabilizer, wing tips of main wings 120, the underside of the aircraft fuselage along the bottom-most portion of aircraft 100, on the nose of aircraft 100, and on the top-most portion of the aircraft fuselage. As used herein, the term “mounted on” means to be secured in a removable temporary fashion or in a permanent integral fashion. The number and respective locations of the proximity sensors 130 are non-limiting. Depending on the implementation, any number of sensors may be used at any location on aircraft 100. Proximity sensors 130 are disposed at extremity locations on aircraft 100 that cannot easily be monitored by the operator of ground vehicle 102. In the example provided, proximity sensors 130 are oriented so respective coverage areas of proximity sensors 130 combine to provide a full 360-degree detection coverage surrounding aircraft 100 so that any obstacles in the space surrounding aircraft 100 or in the vicinity of aircraft 100 can be detected.

Each of proximity sensors 130 is used to detect obstacles that may be present within a detection zone of the respective sensor (e.g., within a particular region that is in the vicinity of the aircraft 100). For example, proximity sensors 130 on main wings 120 may detect object 140 within detection zone 142. Proximity sensors 130 may be any suitable proximity sensor utilizing any suitable technology, such as electromagnetic wave based sensors, sound wave based sensors, visible light based sensors, ultraviolet light based sensors, infrared light based sensors, or the like. Proximity sensors 130 generate signals that indicate the present of obstacles within the detection zones.

In the example provided, computer device 132 is a tablet computer collision warning device that may be mounted on ground vehicle 102 or held by the ground crew during towing. For example, computer device 132 may be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Computer device 132 is illustrated in FIG. 2 with a processor 150, a memory device 152, a display 154, and a speaker 156.

Processor 150 executes instructions based on software or firmware stored in memory device 152. The software or firmware stored on memory device 152 is configured to perform various operations of the method described in FIG. 3. Display 154 may be any suitable visual presentation device, such as a Liquid Crystal Display screen. In the example provided, display 154 is a touch-screen that has an integrated user input device for receiving user selections corresponding with coordinate positions on display 154. Speaker 156 projects audio as sound waves perceptible to the ground crew.

When collision warning system 110 detects an object that poses a risk of collision, computer device 132 may convey the presence of the object to the ground crew using display 154 or speaker 156. For example, computer device 132 may present on display 154 any of the words “STOP,” “SLOW,” “CAUTION,”, “LEFT WINGTIP OBSTACLE” or similar warnings in the local language or dialect selected as outlined in FIG. 3. Similarly, computer device 132 may project audio that includes spoken language warnings in the active local language or dialect. In some embodiments, the spoken language warnings are selected from pre-recorded audio files in each of the available languages and dialects.

Flight Management System 134 is implemented in a computer that coordinates and tracks flight plan and flight progress information for aircraft 100. For example, Flight Management System 134 may know the departure and destination locations for any given flight of aircraft 100. In the example provided, Flight Management System 134 is separate from computer device 132. In some embodiments, features of computer device 132 may be integrated with aircraft 100 and Flight Management System 134.

Communications interfaces 136 may be any devices capable of facilitating communication between computer device 132 and proximity sensors 130, location sensor 138, and Flight Management System 134. In the example provided, communications interfaces 136 are radio antennas for wireless communication of signals between computer device 132 and proximity sensors 130, location sensor 138, and Flight Management System 134. The wireless communication interfaces and wireless communication links may be implemented using any known types of wireless technologies including, but not limited to, BLUETOOTH, near infrared, WLAN, cellular, etc. Without limitation, communications interfaces 136 may include, for example, a WLAN antenna that can be used to communicate information with a WLAN access point or interface over a WLAN communication link, a Bluetooth antenna that can be used to directly communicate information to/from another Bluetooth-enabled device over a Bluetooth communication link, a near infrared network antenna that can be used to directly communicate information to another device over a near infrared communication link, or a cellular network antenna that can be used to communicate information to/from a cellular base station over a cellular communication link.

Location sensor 138 provides latitude and longitude information for the current position of collision warning system 110. In some embodiments, location sensor 138 further includes inertial detectors, such as accelerometers, and rotation sensors (e.g., gyroscopes) to automatically and continuously calculate the aircraft's position, orientation, heading and velocity (direction and speed of movement) without the need for external references once it has been initialized.

Referring now to FIG. 3, a method 200 for multilingual aircraft towing collision warning is illustrated in accordance with teachings of the present disclosure. Steps of method 200 are performed by computer devices associated with aircraft or airports. In the example provided, computer device 132 performs the operations of method 200.

Operation 210 provides an aircraft towing collision warning system. For example, collision warning system 110 with proximity sensors 130 may be provided. As described above, proximity sensors 130 are configured to mount on an aircraft and to generate a proximity signal.

Operation 212 determines whether the collision warning system is mobile. For example, the collision warning system may be permanently located at an airport, or may be integrated with the aircraft. In some embodiments, the mobility of the collision warning system is fixed and is indicated by the firmware or software loaded in the collision warning system. In some embodiments, a user may enter personalization settings into the collision warning system to indicate whether the system is mobile. Accordingly, determining whether the collision system is mobile may be accomplished by referencing the personalization settings or may be omitted when the software or firmware indicates the mobility. When the collision system is mobile, method 200 proceeds to operation 214. Computer device 132 determines the location of aircraft towing in operation 214, where the location includes a country and/or a region. For example, the regions may define geographical, linguistic, governmental, or other sub-locations within the country. In some embodiments, the regions are each associated with a language and a dialect spoken by the majority of the population within the region.

In some embodiments, computer device 132 is configured to retrieve an origination or destination waypoint from Flight Management System 134 and to determine the location based at least in part on the origination or destination waypoint. In some embodiments, computer device 132 is further configured to determine the location based at least in part from a location signal retrieved from location sensor 138. In some embodiments, location sensor 138 is a Global Navigation Satellite System (GNSS) device and the location signal indicates a latitude and longitude of collision warning system 110.

In contrast, when the collision warning system is not mobile, the location will be known and method 200 proceeds to operation 216 directly from operation 212. In operation 216, computer device 132 presents languages and/or dialects based on the location of aircraft towing. In some embodiments, the languages and/or dialects may be described by local linguistic profiles that are visually presented on display 154 of computer device 132. For example, when the location is Mumbai, India, the local linguistic profiles may include languages Hindi, Marathi, English, and other languages common to Mumbai. The local linguistic profiles may be further broken down into dialects of any given language, such as Mumbaiya for Hindi and British or American English for English. In the example provided, the linguistic profiles are presented in response to initialization of the collision warning system and the linguistic profiles are presented as a list of selectable languages and dialects. It should be appreciated that the linguistic profiles may be presented in other ways without departing from the scope of the present disclosure. For example, the linguistic profiles may be presented as national or regional governmental flags.

Computer device 132 receives a language selection input in operation 218. For example, computer device may be configured to receive a user selection input on touchscreen display 154 corresponding to one of the plurality of local linguistic profiles presented in operation 216. Computer device 132 selects an active linguistic profile based on the user selection input and the location to operate the aircraft towing collision system based on the language selection input in operation 220. For example, computer device 132 may alert ground crew of potential aircraft collisions using the active linguistic profile and based on the proximity signal. In some embodiments, the active linguistic profile may be automatically selected in response to initialization of the system. For example, computer device 132 may select the active linguistic profile based on the location signal from location sensor 138 or based on the destination waypoint from Flight Management System 134 in response to initialization of the collision warning system.

In the embodiment provided, method 200 returns to operation 216 to continuously present at least one linguistic profile on a portion of display 154, such as on a corner of display 154. For example, computer device 132 may be configured to generate commands for display 154 to present input selectors for at least one of the local linguistic profiles during operation of the collision warning system and after selection of the linguistic profile. Accordingly, a ground crew that erroneously selected an unfamiliar language or changed personnel may be able to recover to a known language by selecting the continuously presented linguistic profile.

The flowchart that is illustrated in FIG. 3 is exemplary, and is simplified for sake of clarity. In some implementations, additional operations may be implemented even though they are not illustrated in FIG. 3. These additional operations may occur before or after or in parallel and/or concurrently with any of the operations that are illustrated in FIG. 3. It is also noted that some of the operations illustrated in FIG. 3 may be optional and do not need to be included in every implementation of the disclosed embodiments. In some implementations, although not illustrated, the presence or absence of certain conditions may need to be confirmed prior to execution of a operation or prior to completion of a operation. In other words, a operation may include one or more conditions that are to be satisfied before proceeding from that operation to the next operation. For example, in some cases, a timer, a counter or combination of both may execute and need to be satisfied before proceeding to the next operation of the flowchart. As such, any operation can be conditional on other operations that are not illustrated.

Those of ordinary skill in the art further appreciate that the various illustrative logical operations, modules, circuits, and algorithm steps described in connection with the embodiments disclosed herein may be implemented as electronic hardware, computer software, or combinations of both. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A collision warning system, comprising:
a plurality of proximity sensors configured to mount on an aircraft and to generate a proximity signal; and
a computer device communicatively coupled with the plurality of proximity sensors, the computer device configured to:
determine a location in which the collision warning system is located, wherein the location includes at least one of a country and a region;
select an active linguistic profile based at least on part on the location, wherein the active linguistic profile includes at least one of a language and a dialect; and
alert ground crew of potential collisions using the active linguistic profile and based on the proximity signal.

2. The collision warning system of claim 1, further comprising a display, and wherein the computer device is further configured to present on the display a plurality of local linguistic profiles based on the location in response to initialization of the collision warning system.

3. The collision warning system of claim 2, wherein the computer device is further configured to receive a user selection input corresponding to one of the plurality of local linguistic profiles and to select the active linguistic profile based on the user selection input.

4. The collision warning system of claim 2, wherein the computer device is further configured to generate commands for the display to present input selectors for at least one of the plurality of local linguistic profiles during operation of the collision warning system and after selection of the active linguistic profile.

5. The collision warning system of claim 1, wherein the computer device is further configured to retrieve a destination waypoint from a Flight Management System and to determine the location based at least in part on the destination waypoint.

6. The collision warning system of claim 5, wherein the computer device is further configured to select the active linguistic profile based on the destination waypoint in response to initialization of the collision warning system.

7. The collision warning system of claim 1, further comprising a location sensor communicatively coupled with the computer device and configured to generate a location signal that identifies the location, and wherein determining the location is based at least in part on the location signal.

8. The collision warning system of claim 7, wherein the computer device is further configured to select the active linguistic profile based on the location signal in response to initialization of the collision warning system.

9. The collision warning system of claim 7, wherein the location sensor is a Global Navigation Satellite System device.

10. The collision warning system of claim 1, wherein the computer device further includes a display, and wherein the computer device is further configured to present, on the display, collision warnings in the at least one of the language and the dialect of the active linguistic profile.

11. The collision warning system of claim 1, wherein the computer device further includes a speaker, and wherein the computer device is further configured to generate audio that includes spoken language warnings in the at least one of the language and the dialect of the active linguistic profile.

12. A collision warning device for an aircraft, the collision warning device comprising:
a display;
a location sensor configured to generate a location signal; and
a communications interface configured to receive a proximity signal from a plurality of proximity sensors mounted on the aircraft;
wherein the collision warning device is configured to:
determine a location in which the collision warning device is located based on the location signal, wherein the location includes at least one of a country and a region;
select an active linguistic profile based at least on part on the location, wherein the active linguistic profile includes at least one of a language and a dialect; and
alert ground crew of potential collisions of the aircraft with an object using the active linguistic profile and based on the proximity signal.

13. The collision warning device of claim 12, wherein the collision warning device is further configured to:
present on the display a plurality of local linguistic profiles based on the location in response to initialization of the collision warning device;
receive a user selection input corresponding to one of the plurality of local linguistic profiles; and
select the active linguistic profile based on the user selection input.

14. The collision warning device of claim 12, wherein the collision warning device is further configured to select the active linguistic profile based on the location signal in response to initialization of the collision warning device.

15. The collision warning device of claim 12, wherein the collision warning device is a tablet computer device configured to be mounted to a tug.

16. The collision warning device of claim 12, wherein the collision warning device is further configured to present, on the display, collision warnings in the at least one of the language and the dialect of the active linguistic profile.

17. The collision warning device of claim 12, wherein the collision warning device further includes a speaker, and wherein the collision warning device is further configured to generate audio that includes spoken language warnings in the at least one of the language and the dialect of the active linguistic profile.

18. A method for selecting an active linguistic profile for a collision warning system, the method comprising:
determining, with a computer device, a location in which the collision warning system is located, wherein the location includes at least one of a country and a region;
selecting the active linguistic profile based at least on part on the location, wherein the active linguistic profile includes at least one of a language and a dialect; and
alerting ground crew of potential collisions using the active linguistic profile and based on a proximity signal generated by a proximity sensor mounted on an aircraft.
